(19) United States
(12) Patent Application Publication
(10) Pub. No.: US 2024/0367594 A1
(43) Pub. Date: Nov. 7, 2024

(54) VEHICLE DEVICE

(71) Applicants: InnoLux Corporation, Miao-Li County (TW); CARUX TECHNOLOGY PTE. LTD., SINGAPORE (SG)

(72) Inventors: Yu-Chia HUANG, Miao-Li County (TW); Tsung-Han TSAI, Miao-Li County (TW); Kuan-Feng LEE, Miao-Li County (TW); Kun-Feng HUANG, Tainan (Tainan Science Park) (TW); Li-Wei SUNG, Tainan (Tainan Science Park) (TW)

(21) Appl. No.: 18/624,653

(22) Filed: Apr. 2, 2024

(30) Foreign Application Priority Data
May 5, 2023 (CN) 202310497723.6

(51) Int. Cl. B60R 11/02; B60R 11/00; G03B 21/58

(52) U.S. Cl. CPC B60R 11/0229; G03B 21/58; B60R 2011/0084

(57) ABSTRACT

A vehicle device is provided, which includes a light-emitting unit and a screen separately disposed on a vehicle body. In a first state, the screen is stored in a first portion. In a second state, at least a part of the screen is stretched out of the first portion, and the screen has a vertical length of H, which satisfies: H=[(L−d)*tan(θd)]+[(L−d)*tan(θu)] and H<Hv. L is a first horizontal distance between a viewing point and a first barrier element. d is a second horizontal distance between the screen and the first barrier element in the second state. θd is a viewing angle below the horizontal plane when observes from the viewing point to the screen, with θd≤70 degrees. θu is a viewing angle above the horizontal plane when observes from the viewing point to the screen. Hv is a height of the space inside the vehicle.

### CROSS REFERENCE TO RELATED APPLICATIONS

This application claims priority of China Patent Application No. 202310497723.6, filed on May 5, 2023, the entirety of which is incorporated by reference herein.

### BACKGROUND OF THE INVENTION

### Field of the Invention

The present invention relates to a vehicle device, and, in particular, to a projection system for vehicles.

### Description of the Related Art

To enhance the riding experience of passengers in a car, vehicle entertainment systems have become increasingly important. A retractable display system is a suitable design that is suitable a large display area and saves interior space of the vehicle. However, traditional displays, composed of electronic components and rigid mechanical parts, take up a lot of the interior space inside cars, making it difficult to achieve an ideal retractable design.

### BRIEF SUMMARY OF THE INVENTION

A vehicle device is provided. The vehicle device includes a light-emitting unit and a screen. The screen is used to reflect the light emitted from the light-emitting unit, and the screen and the light-emitting unit are separately disposed on a vehicle body. In the first state, the screen is stored in a first portion of the vehicle body. In the second state, at least a part of the screen is stretched out of the first portion, and the screen has a vertical length of H, which satisfies: H=[(L−d)*tan(θd)]+[(L−d)*tan(θu)] and H<Hv. L is the first horizontal distance between a viewing point and a first barrier element encountered in the direction from the screen to the viewing point, d is the second horizontal distance between the screen and the first barrier element in the second state, Od is the viewing angle below the horizontal plane when the human eye observes from the viewing point to the screen, with θd≤70 degrees, θu is the viewing angle above the horizontal plane when the human eye observes from the viewing point to the screen, and Hv is the height of the space inside the vehicle.

### BRIEF DESCRIPTION OF THE DRAWINGS

Aspects of the present disclosure are best understood from the following detailed description when read with the accompanying figures. It should be noted that, in accordance with the standard practice in the industry, various features are not drawn to scale. In fact, the dimensions of the various features may be arbitrarily increased or reduced for clarity of discussion.

FIG. 1 is a schematic view of a vehicle device in some embodiments of the present disclosure.

FIG. 2 is a schematic view of a vehicle device in some embodiments of the present disclosure.

FIG. 3 is a schematic view of a vehicle device in some embodiments of the present disclosure.

FIG. 4 is a schematic view of a vehicle device in some embodiments of the present disclosure.

FIG. 5 is a schematic view of a vehicle device in some embodiments of the present disclosure.

FIG. 6A is a schematic view of a vehicle device in some embodiments of the present disclosure.

FIG. 6B is a schematic of the light-emitting unit and a portion of the vehicle body in FIG. 6A.

FIG. 7A and FIG. 7B are schematic views of the movable device viewed in different directions in some embodiments of the present disclosure.

FIG. 8A and FIG. 8B are schematic views of a movable device viewed in different directions in some embodiments of the present disclosure.

FIG. 9 is a schematic view when performing touch operation on the aforementioned vehicle device.

FIG. 10A is a flowchart illustrating a method for controlling the vehicle device in some embodiments of the present disclosure.

FIG. 10B is a flowchart illustrating a method for controlling the vehicle device in some embodiments of the present disclosure.

FIG. 11 is a flowchart illustrating a method for controlling the vehicle device in some embodiments of the present disclosure.

### DETAILED DESCRIPTION OF THE INVENTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are in direct contact, and may also include embodiments in which additional features may be disposed between the first and second features, such that the first and second features may not be in direct contact.

Spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Unless defined otherwise, all technical and scientific terms used herein have the same meaning as commonly understood by one of ordinary skill in the art to which this invention belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

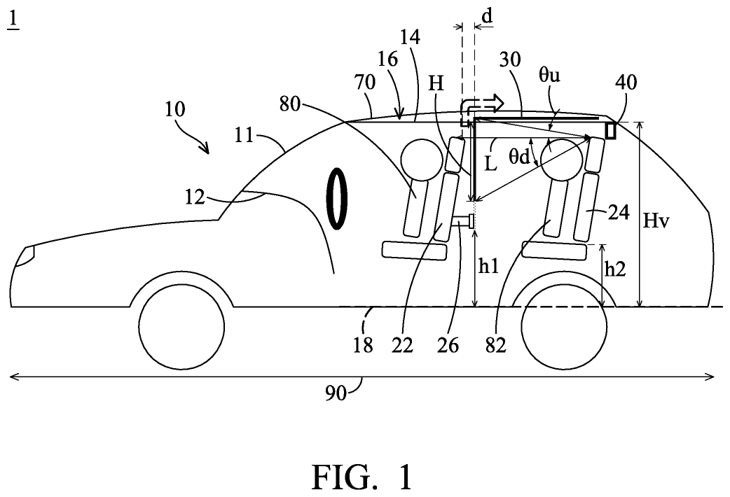

A vehicle device is provided in some embodiments of the present disclosure, such as a vehicle projection system including a projection light source and a projection screen, so as to enhance the user's entertainment experience, and simultaneously achieving advantages of a large display area and not occupying space inside the vehicle. For example, FIG. 1 is a schematic view of a vehicle device 1 in some embodiments of the present disclosure. The vehicle device 1 may be mainly used on a vehicle body 10. For example, the vehicle body 10 may include a windshield 11, a dashboard 12, a roof 14, a floor 18, and a top case 70. An accommodating space 16 may be between the roof 14 and the top case 70. In some embodiments, a front seat 22 and a rear seat 24 may be included in the vehicle body 10 for a driver 80 and a passenger 82, respectively. In some embodiments, the vehicle body 10 may extend in a front-rear direction 90. The vehicle device in the present disclosure may be cars, airplanes, trains, or other suitable modes of transportation.

In some embodiments, the vehicle device 1 may include a screen 30 and a light-emitting unit 40. The accommodating space 16 may be a first portion of the vehicle body 10, while the screen 30 may be positioned within the accommodating space 16 and, when in use, may descend from the opening of the accommodating space 16 and extend outside of it. This allows the screen 30 to be positioned between the front seat 22 and the rear seat 24 or in other interior spaces of the vehicle for the passenger 82 to watch. When the screen 30 is not in use, it can be stored into the accommodating space 16 to save spaces in the vehicle. In some embodiments, the screen 30 may also be folded down for storage and positioned between the front seat 22 and the rear seat 24 (similar to a sun visor) or in another interior space. In some embodiments, the light-emitting unit 40 may be a projection unit that projects images onto the screen 30. The light-emitting unit 40 and the screen 30 may be separated from each other and disposed on the vehicle body 10 for display, such as behind the rear seat 24.

In some embodiments, a fixed element 26 may be disposed in the vehicle body 10, such as in front of the front seat 22, but it is not limited thereto. The fixed element 26 may be used for defining a final position of the screen 30 when the screen 30 descends from the roof 14, but it is not limited thereto. For example, the fixed element 26 may be used for affixing the screen 30 to prevent vibration or shaking during vehicle movement from affecting the viewing experience. The fixed element 26 may be positioned at a height of h1 from the floor 18, while the seat surface of the rear seat 24 may be positioned at a height of h2 from the floor 18. The heights h1 and h2 refer to the distances in the direction perpendicular to the floor 18. It should be noted that the height h1 may be greater than the height h2 to enhance the viewing experience of the user. In some embodiments, the fixed element 26 may include various securing elements such as hooks, latches, magnets, suction cups, adhesive materials for repeated sticking, Velcro, and other similar fastening components.

In some embodiments, when the screen 30 descends from the roof 14 and reaches a specific position, the rigidity of the screen 30 may be increased to prevent shaking and maintain the user's viewing experience. This may be achieved by increasing the vertical or horizontal rigidity of the screen 30 using methods such as electrical, magnetic, stress, pressure, or other suitable means, but it is not limited thereto. In some embodiments, when the screen 30 descends from the roof 14, the front seat 22 may be moved in the front-rear direction 90 (manually or automatically) to avoid direct contact between the screen 30 and the backrest of the front seat 22. In some embodiments, the bottom of the screen 30 may include fixtures with adjustable positions (e.g., height, angle) to allow the screen 30 to be adjusted to achieve optimal viewing experience according to different user needs.

In some embodiments, the position between the screen 30 and the user may be defined to provide better viewing experience for the user. The first state is defined as a state when the screen 30 is stored. The second state is defined as a state when the screen is disposed at the viewing position. In the second state, the screen 30 may be stretched out from the accommodating space 16 through an opening of the accommodating space 16. For example, as shown in FIG. 1, the distance between the first barrier element encountered (e.g., the front seat 22) when observing from a viewing point (e.g., top of the rear seat 24) along the front-rear direction 90 to the screen 30 is designated as the first horizontal distance L. The horizontal distance between the screen 30 and the first barrier element in the second state in the front-rear direction 90 is designated as a second horizontal distance d. The viewing angle below the horizontal plane when the human eye observes from the viewing point to the screen is designated as a viewing angle θd (i.e. the human eye's ability to observe from a lower perspective). The viewing angle above the horizontal plane when the human eye observes from the viewing point to the screen is designated as a viewing angle θu. The height of the space inside the vehicle (e.g. the vertical distance from the roof 14 to the floor 18) is designated as a height Hv. The length of the screen 30 in the direction perpendicular to the floor 18 is designated as a vertical length H, which is the length from the opening of screen 30 lowered from the roof 14. In some embodiments, these dimensions may satisfy the following relationship:

H=[(L−d)*tan(θd)]+[(L−d)*tan(θu)] (1)

H<Hv (2)

Where equation (1) means that the vertical length H of the screen 30 may be defined as the upper field of view plus the lower field of view of the user, and equation (2) means that the vertical length H of the screen 30 is less than the space inside the vehicle. Therefore, when the size of the vehicle satisfies the aforementioned relationships, this ensures that users can clearly view every portion of the screen 30 to enhance their viewing experience. It should be noted that equations (1) and (2) are not limited to the present embodiment, while other embodiments of the present disclosure also satisfy the relationships. In some embodiments, the light-emitting unit 40 and the viewing point may be disposed on the same side of the screen 30, so the screen 30 may reflect the light emitted from the light-emitting unit 40 for the user to see.

In some embodiments, the first horizontal distance L may be greater than or equal to 50 cm, and the second horizontal distance d may be greater than or equal to 1 cm and less than or equal to 50 cm, which avoids the screen 30 from in contact with barrier element (such as the front seat 22) when stretching the screen 30 from the opening of the accommodating space 16. Therefore, the smoothness when the screen 30 is stretching is increased. The viewing angle θd may be less than or equal to 70 degrees, and the viewing angle θu may be less than or equal to 30 degrees. In some embodiments, the viewing angle θd may be greater than the viewing angle θu to provide better viewing experience to the user, but the present disclosure is not limited thereto. Alternatively, other dimensions may be employed to allow users to have a clearer view of the image projected by the light-emitting unit 40 onto the screen 30. In other words, users can clearly see the image reflected on the screen 30, which is produced by the light emitted from the light-emitting unit 40.

In some embodiments, materials for the screen 30 may include semi-transparent screen, leather, wood grain, mirrors, adjustable reflectance layers (such as cholesteric liquid crystal (CLC)), adjustable haze layers (such as polymer-dispersed liquid crystal (PDLC) or polymer network liquid crystal (PNLC)), adjustable transparency layers (such as dichroic dye liquid crystal (DDLC), cholesteric liquid crystal (CLC), electrochromic (EC) materials, photochromic materials, suspended particle devices (SPD), electronic ink (e ink), rigid materials, elastic materials, plastic materials, textile materials, or combinations thereof, but it is not limited thereto.

In some embodiments, in addition to positioning the screen 30 directly in front of the passenger 82, it may also be placed on the side of the passenger 82 (e.g., a direction facing the car door). In this case, the light-emitting unit 40 may be disposed under the rear seat 24 to allow for display functionality on the side of the passenger 82 as well.

In some embodiments, the screen 30 may have touch functionality, which may be achieved by integrating optical, capacitive, pressure, or ultrasonic components within the screen 30. Additionally, a photosensitive coupling device (CCD) may be disposed in the vehicle body 10 to detect user gestures and enable gesture-based operations by the photosensitive coupling device. The photosensitive coupling device may be integrated within the light-emitting unit 40 or disposed on a position separately from the light-emitting unit 40 in the vehicle body 10 to detect the gestures, allowing users to control the vehicle device 1 using gestures. In some embodiments, additional controllers (such as a touch panel or control elements disposed within the vehicle) may be provided to control the mechanical movements of the screen 30 or interact with the interface displayed on the screen 30.

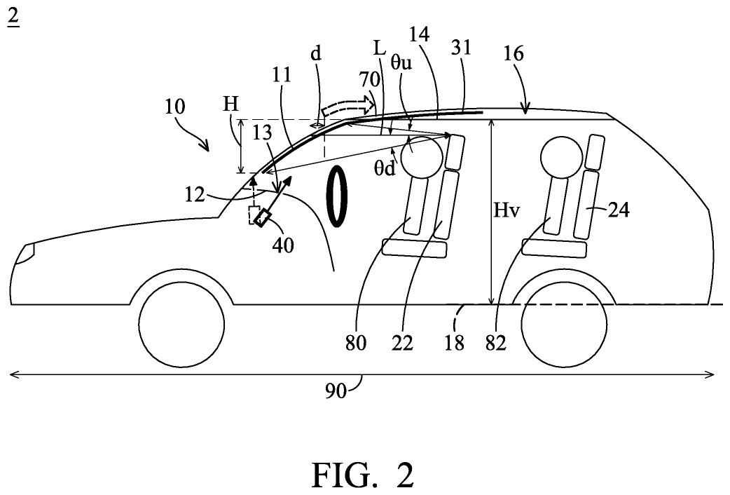

FIG. 2 is a schematic view of a vehicle device 2 in some embodiments of the present disclosure. The vehicle device 2 may include a screen 31 and a light-emitting unit 40. In some embodiments, the screen 31 of the vehicle device 2 may be positioned in front of the front seat 22 for the driver 80 to view. The screen 31 may be adjustably disposed in the accommodating space 16, and their positional relationship may also satisfy the aforementioned relationships (1) and (2). The viewing point may be the top of the front seat 22, and the first barrier element may be the windshield 11. In this case, the light-emitting unit 40 may be disposed below the dashboard 12 or on other position of the interior space of the vehicle to project light onto the screen 31. The dashboard 12 may have an opening 13, allowing the light from the light-emitting unit 40 to pass through the opening 13 and reach the screen 31. In some embodiments, there may be more than one openings 13 (e.g., two) to allow the light-emitting unit 40 to project through different openings 13 onto different positions. In some embodiments, the light-emitting unit 40 may be rotated to project onto the windshield 11 in addition to the screen 31, which allows the user view images by the light emitted by the light-emitting unit 40 and reflected through the screen 31, thereby achieving a heads-up display.

In some embodiments, the transparency of the screen 31 is adjustable. For example, the screen 31 may include dichroic dye liquid crystal or other combinations of aforementioned screen materials, but it is not limited thereto. This allows the transparency of specific positions on the screen 31 to be adjusted by applying electric current, thereby avoiding interference from external light and enhancing the projection. Therefore, it is able to provide users with entertainment or effectively utilize the space inside the vehicle. Additionally, in case of emergency situations, the transparency of the screen 31 may be increased to enable users for observing the surrounding environment outside the vehicle.

Although FIG. 2 shows that the screen 31 is folded downward, the present disclosure is not limited thereto. For example, in some embodiments, the screen 31 may be disposed along the windshield 11. In some embodiments, the curvature of the screen 31 may be identical or substantially identical to the curvature of the windshield 11. Therefore, the screen 31 may be roughly follow the curvature of the windshield 11 or closely adhere to the shape of the windshield 11. The terms “substantially” typically means+/−20% of the stated value, more typically +/−10% of the stated value, more typically +/−5% of the stated value, more typically +/−3% of the stated value, more typically +/−2% of the stated value, more typically +/−1% of the stated value and even more typically +/−0.5% of the stated value. The stated value of the present disclosure is an approximate value. When there is no specific description, the stated value includes the meaning of “substantially”.

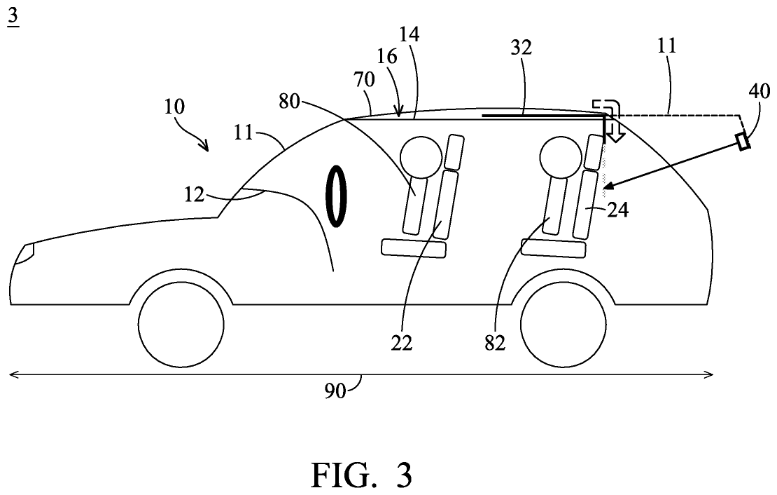

FIG. 3 is a schematic view of a vehicle device 3 in some embodiments of the present disclosure. The vehicle device 3 may include a screen 32 and a light-emitting unit 40. In some embodiments, the light-emitting unit 40 of the vehicle device 3 may be disposed on the tailgate 11 of the vehicle body 10, and the screen 32 may descend from the behind of the rear seat 24. Therefore, when the tailgate 11 opens, the light-emitting unit 40 may project images onto the screen 32 to allow users outside the vehicle to see the images.

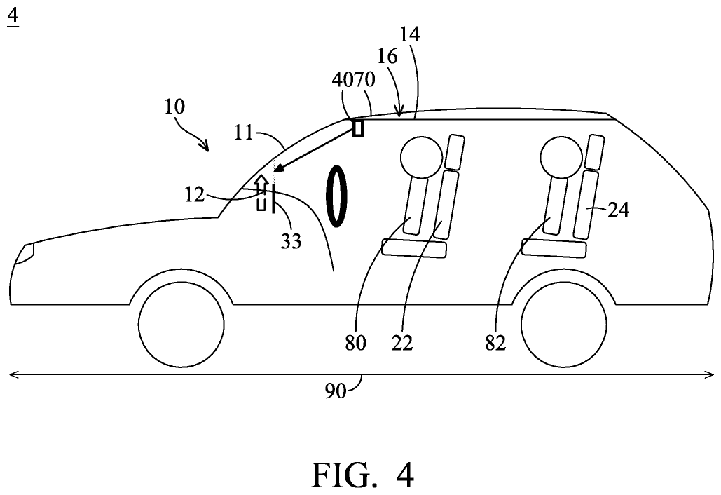

Besides disposing the screen in the accommodating space 16 of the roof 14, the screen may be disposed on other positions. For examples, FIG. 4 is a schematic of a vehicle device 4 in some embodiments of the present disclosure. The vehicle device 4 may include a screen 33 and a light-emitting unit 40, wherein the screen 33 may be disposed in the dashboard 12, and the light-emitting unit 40 may be disposed on the roof 14. When in use, the screen 33 may rise along the dashed line in FIG. 4. When not in use, the screen 33 may descend back into the dashboard 12. Therefore, the screen 33 may be hided to increase the usable space inside the vehicle.

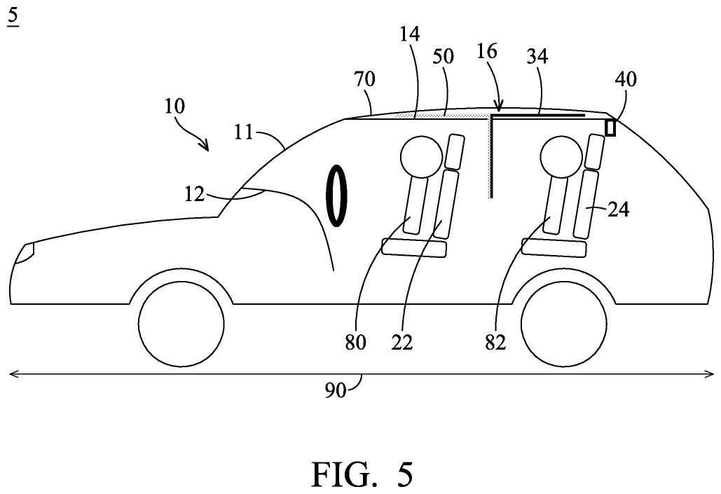

FIG. 5 is a schematic view of a vehicle device 5 in some embodiments of the present disclosure. Besides the screen 34 and the light-emitting unit 40, the vehicle device 5 may also include an adjustable panel 50 disposed in the accommodating space 16. When in use, the screen 34 and the adjustable panel 50 may be taken out from the accommodating space 16. It should be noted that the screen 34 and the adjustable panel 50 are separated from each other when in the first state, and they may be combined together when in the second side, such as overlapping in the front-rear direction 90. Therefore, the transparency of the screen 34 and the adjustable panel 50 may be further adjusted to enhance the viewing effect. For example, when the passenger 82 is watching video, the driver 80 will not be interfered. Moreover, the screen 34 and the adjustable panel 50 are disposed separately, the overall thickness may be decreased to achieve miniaturization.

In some embodiments, materials for the adjustable panel 50 may include semi-transparent screen, leather, wood grain, mirrors, adjustable reflectance layers (such as cholesteric liquid crystal (CLC)), adjustable haze layers (such as polymer-dispersed liquid crystal (PDLC) or polymer network liquid crystal (PNLC)), adjustable transparency layers (such as dichroic dye liquid crystal (DDLC), cholesteric liquid crystal (CLC), electrochromic (EC) materials, photochromic materials, suspended particle devices (SPD), electronic ink (e ink), rigid materials, elastic materials, plastic materials, textile materials, or combinations thereof, but it is not limited thereto.

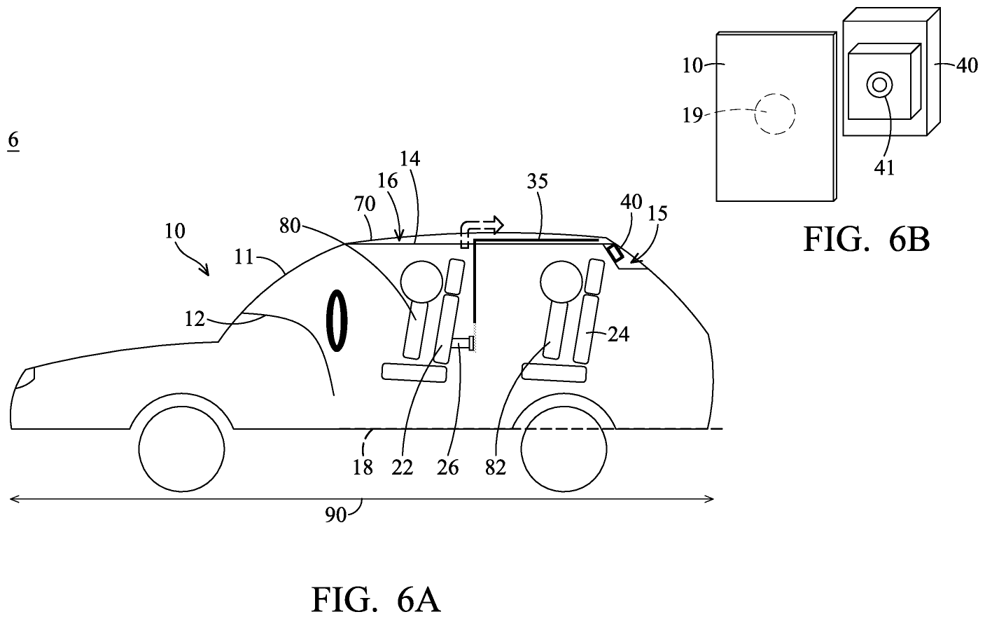

In some embodiments, the light-emitting unit 40 may be hided in the vehicle body 10. For example, FIG. 6A is a schematic view of a vehicle device 6 in some embodiments of the present disclosure. The vehicle device 6 may include a screen 35 and a light-emitting unit 40. The screen 35 may be disposed in the accommodating space 16, the vehicle body 10 may include an accommodating space 15, and the light-emitting unit 40 may be disposed in the accommodating space 15 to protect the light-emitting unit 40 and provide an aesthetically pleasing effect. FIG. 6B is a schematic of the light-emitting unit 40 and a portion of the vehicle body 10 in FIG. 6A. For example, the light-emitting unit 40 may include a display area 41, and an opening 19 may be formed on the vehicle body 10. In some embodiments, the display area 41 and the opening 19 may overlap each other when viewed in a direction parallel to the display area 41 and the opening 19 arranges, so the light emitted from the light-emitting unit 40 may pass through the opening 19 to reach the screen 35.

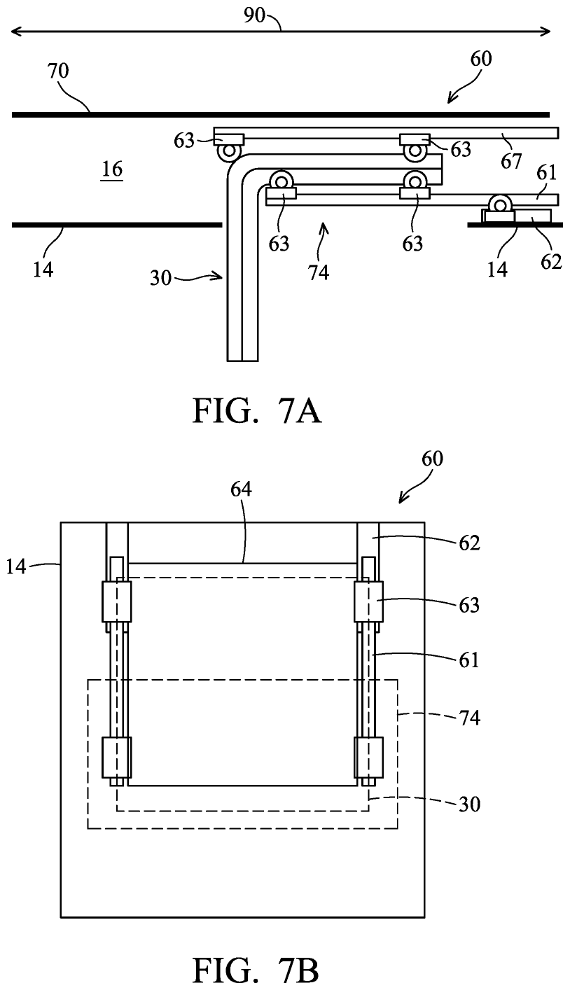

FIG. 7A and FIG. 7B are schematic views of the movable device 60 viewed in different directions in some embodiments of the present disclosure. For example, the movable device 60 may be disposed in the accommodating space 16. The screen 30 may be disposed on the movable device 60, and the movable device 60 may move the screen 30 to allow the screen 30 moving in and out from the accommodating space 16 by the movable device 60. In some embodiments, the movable device 60 may include a first slide rail 61, a second slide rail 62, a movable support element 63, a supporting plate 64, and a third slide rail 67. In some embodiments, the movable device 60 may be disposed in the accommodating space 16 (i.e. between the roof 14 and the top case 70). The second slide rail 62 may be affixed on the roof 14 to adjust the initial position of the screen 30 when stretching. The first slide rail 61 may move relative to the second slide rail 62 in the front-rear direction 90 to store or stretch the screen 30. The movable support element 63 may be, for example, a pulley or a slider, and may be disposed between the first slide rail 61 and supporting plate 64 and disposed on the third slide rail 67. This allows the supporting plate 64 and the screen 30 moving relative to the first slide rail 61 and the third slide rail 67 through the movable support element 63. The screen 30 may be affixed on the supporting plate 64 to allow the screen 30 move with the supporting plate 64 when the supporting plate 64 is moving, so the screen 30 may expose from an opening 74 of the roof 14. In some embodiments, the movable device 60 may also include a driving element (e.g. a motor or the like) to drive the screen 30 and the supporting plate 64 moving relative to the roof 14. The third slide rail 67 may be disposed on the top case 70 for the movable support element 63 to be disposed. In some embodiments, the third slide rail 67 may be omitted, and the movable support element 63 may be directly disposed on the top case 70.

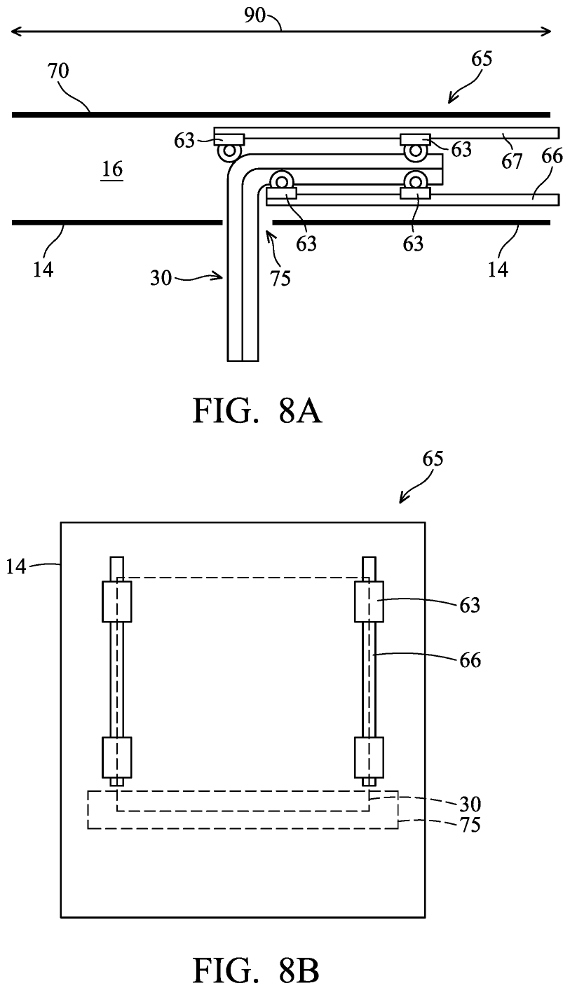

FIG. 8A and FIG. 8B are schematic views of a movable device 65 viewed in different directions in some embodiments of the present disclosure. The movable device 60 may be disposed in the accommodating space 16, for example. The movable device 65 may mainly include the movable support element 63, a slide rail 66, and the third slide rail 67. The slide rail 66 may be affixed on the roof 14, and the movable support element 63 may be disposed between the slide rail 66 and the screen 30 and disposed on the third slide rail 67. The screen 30 may directly connect to the movable support element 63, so the screen 30 may also move relative to the roof 14 in the front-rear direction 90 when the movable support element 63 moves relative to the slide rail 66, thereby exposing the screen 30 from the opening 75 of the roof 14. The third slide rail 67 may be disposed on the top case 70 for disposing the movable support element 63. In some embodiments, the third slide rail 67 may be omitted, and the movable support element 63 may be directly disposed on the top case 70. Since the movable device 65 does not need support plate, the size of the opening 75 may be reduced for achieving aesthetic functionality. In some embodiments, the durability of the movable device 60 or the movable device 65 may be enhanced by incorporating designs for increased friction resistance or dust protection at the opening 74 or the opening 75.

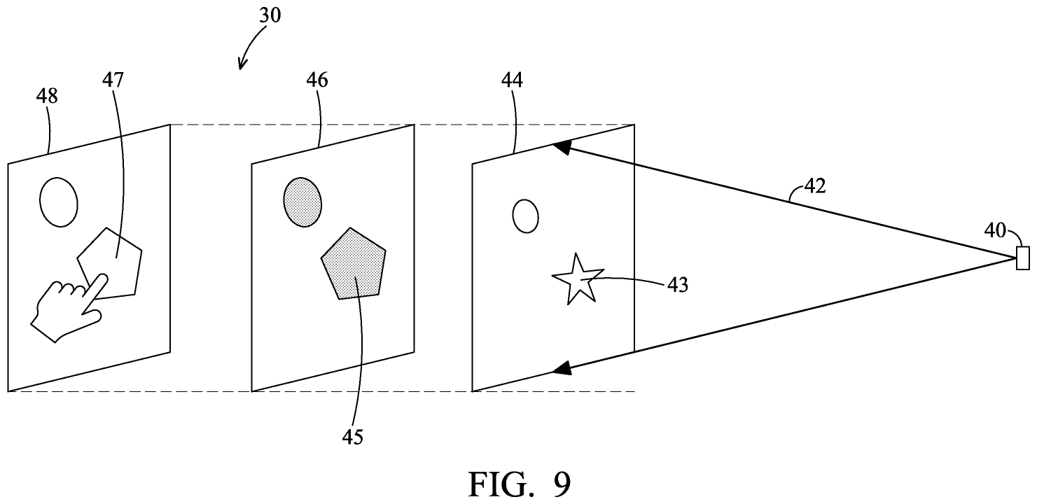

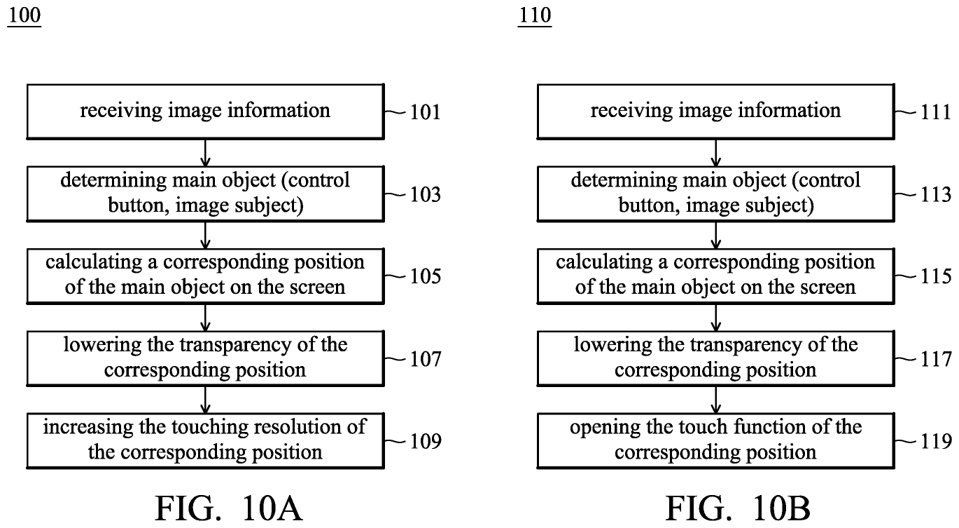

FIG. 9 is a schematic view when performing touch operation on the aforementioned vehicle device. For example, the screen 30 may mainly include an image layer 44, a display layer 46, and a touch layer 48. FIG. 10A is a flowchart illustrating a method 100 for controlling the vehicle device in some embodiments of the present disclosure. In some embodiments, in operation 101, image information is obtained, such as the information of the main object 43 projected onto the image layer 44 when the light-emitting unit 40 projects the projected light onto the image layer 44. In some embodiments, in operation 103, the main object 43 is determined, such as a control button or an image subject. In some embodiments, in operation 105, the corresponding position of the main object 43 displayed on the screen 30 is calculated.

In some embodiments, in operation 107, the screen transparency corresponding to the position of the main object 43 is decreased, such as by reducing the transparency of the background object 45 of the display layer 46. The display layer 46, for example, may include an adjustable transparency layer. The background object 45, for instance, may correspond to the main object 43 (e.g., overlapping with each other), and the area of the background object 45 may be greater than the area of the main object 43 to provide a clearer display of the main object 43. The transparency of the area outside the background object 45 may be maintained to allow the user to see the situation behind the screen.

In some embodiments, in operation 109, the touch resolution at the corresponding position is increased, such as increasing the touch resolution of the touch area 47 in the touch layer 48. The touch area 47 may correspond to the main object 43 (e.g. overlapping with each other) to allow users to interact with the screen through touch, and it may have a higher resolution at specific positions. For example, when the user needs to type in numbers, the resolution at positions of the numbers may be higher, and the resolution at the background may be lower to save energy or prevent from touching by mistake. In some embodiments, the area of the touch area 47 may be less than the area of the main object 43.

FIG. 10B is a flowchart illustrating a method 110 for controlling the vehicle device in some embodiments of the present disclosure. In some embodiments, in operation 111, image information is obtained, such as the information of the main object 43 projected onto the image layer 44 when the light-emitting unit 40 projects the projected light onto the image layer 44. In some embodiments, in operation 113, the main object 43 is determined, such as a control button or an image subject. In some embodiments, in operation 115, the corresponding position of the main object 43 displayed on the screen 30 is calculated. In some embodiments, in operation 117, the screen transparency corresponding to the position of the main object 43 is decreased, such as by reducing the transparency of the background object 45 of the display layer 46. The display layer 46, for example, may include an adjustable transparency layer. The background object 45, for instance, may correspond to the main object 43 (e.g., overlapping with each other), and the area of the background object 45 may be greater than the area of the main object 43 to provide a clearer display of the main object 43. Finally, in operation 119, touch function at the correspond position is opened, such as open the touch function at the touch area 47 to allow users to interact with the screen through touch, and to save energy or prevent from touching by mistake. In some embodiments, the area of the touch area 47 may be less than the area of the main object 43.

In some embodiments, the light-emitting unit 40 may also adjust or selectively project the specific main object 43 based on the driver's position. This allows for optimization of the touch control method for specific defined areas (e.g., when adjusting the volume, the up and down touch directions, structure, algorithms, etc., may be optimized for better touch sensitivity).

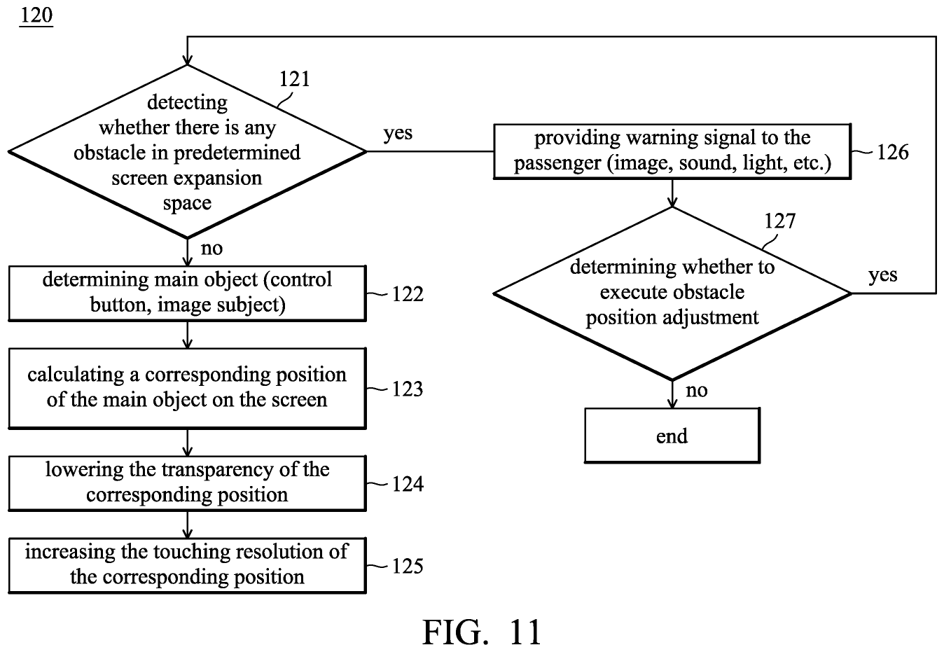

FIG. 11 is a flowchart illustrating a method 120 for controlling the vehicle device in some embodiments of the present disclosure. First, in operation 121, detecting whether there is any obstacle in predetermined screen expansion space. If there is no obstacle, the method goes to the operation 122 for determining the main object 43, such as control button or image subject. In operation 123, the corresponding position of the main object 43 displayed on the screen is calculated. In operation 124, the screen transparency corresponding to the position of the main object 43 is decreased, such as by reducing the transparency of the background object 45 of the display layer 46. The display layer 46, for example, may include an adjustable transparency layer. The background object 45, for instance, may correspond to the main object 43 (e.g., overlapping with each other), and the area of the background object 45 may be greater than the area of the main object 43 to provide a clearer display of the main object 43. In operation 125, the touch resolution at the corresponding position is increased, such as increasing the touch resolution of the touch area 47. The touch area 47 may correspond to the main object 43 (e.g. overlapping with each other) to allow users to interact with the screen through touch.

If the result in operation 121 is no, and then performs operation 126 to provide warning information to the passenger (e.g. image, sound, light, etc.) to remind the passenger adjusting the obstacle. Afterwards, operation 127 is performed to determining whether the position of the obstacle needs to be adjusted. If the determination is yes, go back to the operation 121. If the determination is no, end the method 120. Therefore, it is possible to further determine whether there is any obstacle in the light path when using the light-emitting unit 40 to project light onto the screen, which ensures that the light may be projected onto the screen.

In summary, a vehicle device and operation methods thereof are provided in some embodiments of the present disclosure. The screen and the light-emitting unit are separated from each other, so a wide display area may be achieved, and the space inside the vehicle is not occupied. Moreover, the durability of the device may be increased. Furthermore, by adjusting the size and position of the vehicle device to meet specific criteria, it can enhance the user's comfort while watching videos. The features of the embodiments may be combined with each other as long as they do not violate the inventive spirit or conflict with each other.

Although embodiments of the present disclosure and their advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, and composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope of such processes, machines, manufacture, and compositions of matter, means, methods, or steps. In addition, each claim constitutes a separate embodiment, and the combination of various claims and embodiments are within the scope of the disclosure.

What is claimed is:

1. A vehicle device, comprising:
a light-emitting unit; and
a screen used for reflecting light emitted from the light-emitting unit, wherein the screen and the light-emitting unit are disposed separately on a vehicle body;
wherein the screen is stored in a first portion of the vehicle body in a first state, and in a second state, at least a part of the screen is stretched out of the first portion, and the screen has a vertical length H, which satisfies:
$$H = [ ( L - d ) * tan ( θ d ) ] + [ ( L - d ) * tan ( θ u ) ] and$$
$$H < Hv$$
wherein:
L is a first horizontal distance between a viewing point and a first barrier element encountered in a direction from the screen to the viewing point,
d is a second horizontal distance between the screen and the first barrier element in the second state,
θd is a viewing angle below the horizontal plane when the human eye observes from the viewing point to the screen, with θd≤70 degrees,
θu is a viewing angle above the horizontal plane when the human eye observes from the viewing point to the screen, and
Hv is a height of a space inside the vehicle.

2. The vehicle device as claimed in claim 1, wherein θu<θd, and θu≤30 degrees.

3. The vehicle device as claimed in claim 1, wherein the first portion is an accommodating space of a roof, the first portion comprises an opening, and the screen is stretched out from the first portion through the opening.

4. The vehicle device as claimed in claim 1, further comprising a movable device disposed in the first portion, wherein the movable device comprises a first slide rail and a second slide rail, the first slide rail is used for storing or stretching the screen, and the second slide rail is used for adjusting an initial position of the screen when being stretched.

5. The vehicle device as claimed in claim 4, wherein the movable device further comprises a supporting plate and a movable support element, the movable support element is disposed between the first slide rail and the support plate, and the screen is disposed on the support plate.

6. The vehicle device as claimed in claim 5, wherein the movable device further comprises a third slide rail disposed on the vehicle body, wherein the movable support element is disposed on the third slide rail.

7. The vehicle device as claimed in claim 5, wherein the movable support element is directly disposed on the vehicle body.

8. The vehicle device as claimed in claim 4, wherein the second slide rail is affixed on the vehicle body.

9. The vehicle device as claimed in claim 1, further comprising a fixed element disposed on the first barrier element and used for affixing the screen.

10. The vehicle device as claimed in claim 1, wherein the light-emitting unit is a projecting unit used for projecting an image onto the screen.

11. The vehicle device as claimed in claim 1, wherein the light-emitting unit and the viewing point are on a same side of the screen.

12. The vehicle device as claimed in claim 1, wherein curvature of the screen and curvature of a windshield of the vehicle body are identical.

13. The vehicle device as claimed in claim 12, wherein the screen is disposed along the windshield.

14. The vehicle device as claimed in claim 1, further comprising an adjustable panel stored in the first portion, wherein the screen and the adjusting panel are separated from each other in the first state, and the screen and the adjusting panel overlap each other in the second state.

15. The vehicle device as claimed in claim 1, wherein the vehicle body comprises a tailgate, and the light-emitting unit is disposed on the tailgate.

16. The vehicle device as claimed in claim 1, wherein a transparency of the screen is adjustable.

17. The vehicle device as claimed in claim 1, wherein the first horizontal distance is greater than or equal to 50 cm.

18. The vehicle device as claimed in claim 1, wherein the second horizontal distance is greater than or equal to 1 cm, and less than or equal to 50 cm.

19. The vehicle device as claimed in claim 1, wherein the vehicle body comprises a dashboard, an opening is formed on the dashboard, and the light-emitting unit is disposed below the dashboard, wherein the light emitted from the light-emitting unit passes through the opening.

20. The vehicle device as claimed in claim 1, wherein the vehicle body comprises a first accommodating space and a second accommodating space separated from each other, the screen is disposed in the first accommodating space, and the light-emitting unit is disposed in the second accommodating space.
